(19) United States
(12) Patent Application Publication
(10) Pub. No.: US 2013/0104710 A1
(43) Pub. Date: May 2, 2013

(54) FLUFF PACK PORTIONING APPARATUS

(71) Applicant: HOLLYMATIC CORPORATION, Countryside, IL (US)

(72) Inventor: Hardev S. SOMAL, Lagrange Highlands, IL (US)

(73) Assignee: HOLLYMATIC CORPORATION, Countryside, IL (US)

(21) Appl. No.: 13/666,337

(22) Filed: Nov. 1, 2012

Related U.S. Application Data
(60) Provisional application No. 61/554,253, filed on Nov. 1, 2011.

(51) Int. Cl. B02C 23/02; B26D 7/18; B26D 7/06

(52) U.S. Cl. 83/26; 83/155; 83/110; 241/101.5; 83/13; 83/23

(57) ABSTRACT

Embodiments may disclose a fluff portioning apparatus including: a guide coupled to a meat grinder, the guide configured to receive a meat portion from the meat grinder and transport the meat portion away from the meat grinder in a direction towards a cutting blade; the cutting blade configured to cut the meat portion received from the guide, creating a first meat portion; and a front conveyer which transports the first meat portion in a direction away from the cutting blade using a front conveyer belt.

### CROSS-REFERENCE TO RELATED APPLICATION

This application claims priority under 35 USC §119 to U.S. Provisional Application No. 61/554,253, filed Nov. 1, 2011, the contents of which are herein incorporated by reference in its entirety.

### BACKGROUND

1. Technical Field

Embodiments relate to a fluff pack portioning apparatus. More particularly, embodiments relate to a fluff pack portioning apparatus for forming fluffed up portions of meat.

2. Description of the Related Art

A related art meat portioning apparatus compresses ground meat into a compact, brick shape. In the related art, the meat portioning apparatus compresses ground meat into a compact, brick shape using a forming die. The forming die of the related art receives ground meat from a grinder, and pushes the ground meat through the interior brick-shaped cavity, creating the compact, brick-shaped portions of meat. This meat portioning apparatus may crush the grain and squeeze the blood out of the meat.

Customers want a meat product that gives a fresher, more natural appearance. One way to provide a fresher, more natural appearance is to fluff up portions of the meat. Fluffed up portions of meat allows generous amounts of air inside the meat, creating a “fluffed up” appearance. Fluffed up portions of meat have a wavy, noodle-like pattern, which enhances their appearance when packaged for a grocery store or a butcher's showcase. Additionally, fluffed up portions of meat tends to cook more uniformly due to the larger amounts of air and air channels within the meat. Further, since more air molecules are in the final packaged product, the weight of a fluffed up portion may be maintained by using less meat.

### SUMMARY

Exemplary embodiments provide a fluff pack portioning apparatus for forming fluffed up portions of meat.

According to example embodiments, a fluff portioning apparatus includes: a guide coupled to a meat grinder, the guiding configured to receive a meat portion from the meat grinder and transport the meat portion away from the meat grinder in a direction towards a cutting blade; the cutting blade configured to cut the meat portion received from the guide, creating a first meat portion; and a front conveyer which transports the first meat portion in a direction away from the cutting blade using a front conveyer belt.

A controller may be configured to drive the front conveyer at a first speed and the guide at a second speed, the first speed being faster than the second speed.

The guide may be a rear conveyer which transports the meat portion away from the meat grinder and towards the cutting blade using a rear conveyer belt.

The controller may drive the front conveyer belt at the first speed, the first speed being in a range of two to three times faster than the second speed of a rear conveyer belt.

The first speed may be two times faster than the second speed.

The controller may be configured to drive the front conveyer at a first speed.

The first speed of the front conveyer belt may be driven in a range of 20 revolutions per minute to 600 revolutions per minute.

A photo-eye sensor may be included in the fluff portioning apparatus for detecting an edge of the meat portion, the photo-eye sensor controlling the cutting blade such that the meat portion is cut at a same uniform length.

The same uniform length may be in a range of two inches to ten inches.

The same uniform lengthy may be two inches.

A timer counter may be included in the fluff portioning apparatus for controlling the cutting blade such that the meat portion is cut a same uniform time.

The same uniform time may be 10 seconds.

The fluff portioning apparatus may turn off when the meat grinder is off.

A grinding plate which attaches to the meat grinder and an adapter ring which interlocks and couples the meat grinder and the grinding plate to the fluff portioning apparatus may be included in the fluff portioning apparatus.

According to example embodiments, a method of creating fluffed up portions of meat includes: receiving the meat from a meat grinder; and cutting the meat into fluffed up portions with a cutting blade of a fluff portioning apparatus.

The method may include a rear conveyer and a front conveyer in the fluff portioning apparatus, the meat may be transported away from the meat grinder in a direction towards the cutting blade using the rear conveyer, and the fluffed up portions may be transported in a direction away from the cutting blade using the front conveyer.

The method may include a controller configured to drive the front conveyor at a first speed and the rear conveyer at a second speed, the first speed being faster than the second speed.

The method may include detecting an edge of the meat using a photo-eye sensor, the photo-eye sensor controlling the cutting blade such that the meat is cut at a same uniform length.

The method may include controlling the cutting blade using a timer counter such that the meat is cut a same uniform time.

The method may include turning off the fluff portioning apparatus when the meat grinder is off.

A grinding plate which attaches to the grinder and an adapter ring which interlocks and couples to the meat grinder and the grinder plate to the fluff portioning apparatus may be included in the method.

According to example embodiments, a method of creating fluffed up portions of meat in a fluff portioning apparatus, includes: receiving a meat portion from a grinder, the grinder attached to the fluff portioning apparatus with a grinding plate and an adapter ring; transporting the meat portion away from the grinder at a second speed and towards a cutting blade; cutting the meat portion into a first fluffed up portion of meat with the cutting blade; and transporting the first fluffed up portion of meat away from the cutting blade at a first speed.

### BRIEF DESCRIPTION OF THE DRAWINGS

Illustrative, non-limiting example embodiments will be more clearly understood from the following detailed description taken in conjunction with the accompanying drawings.

FIG. 1 is a diagram illustrating an exemplary embodiment of a fluff portioning apparatus with a rear conveyer.

FIG. 2 is a diagram illustrating a side view of a fluff portioning apparatus with a photo-eye sensor according to an exemplary embodiment.

FIG. 3 is an overall configuration of the fluff portioning apparatus with the rear conveyer.

FIG. 4 is a diagram illustrating an exemplary embodiment of a fluff portioning apparatus with a timer counter.

FIG. 5 is a diagram illustrating an exemplary embodiment of a grinding plate.

### DETAILED DESCRIPTION OF THE EMBODIMENTS

Various example embodiments will be described more fully hereinafter with reference to the accompanying drawings, in which some example embodiments are shown. Example embodiments may, however, be embodied in many different forms and should not be construed as limited to the example embodiments set forth herein. Rather, these example embodiments are provided so that this disclosure will be thorough and complete, and will fully convey the scope of the embodiments to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected”, “attached”, or “coupled” to another element, it can be directly connected, attached, coupled to the other element or intervening elements may be present. In contrast, when an element is referred to as being “directly connected”, “directly attached”, or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which these embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

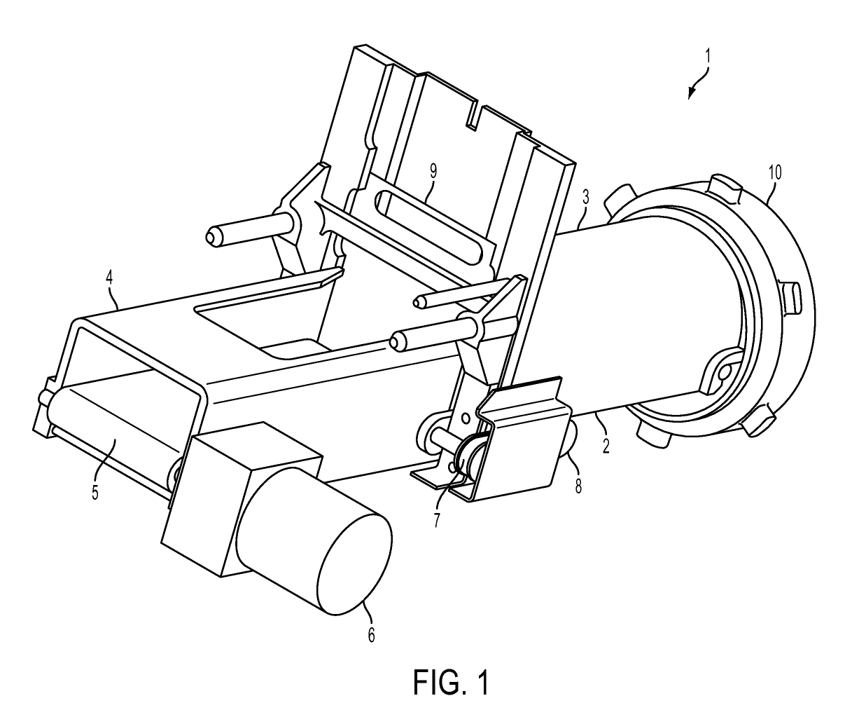

FIG. 1 is a diagram illustrating an exemplary embodiment of a fluff portioning apparatus with a rear conveyer belt.

Referring to FIG. 1, an exemplary fluff portioning apparatus 1 may include a rear conveyer 2, a front conveyer 4, a motor 6, a first pulley 7, a second pulley 8, and a cutting blade 9.

The rear conveyer 2 and the front conveyer 4 may include a rear conveyer belt 3 and a front conveyer belt 5, respectively. The rear conveyer belt 3 and the front conveyer belt 5 may be used to transport meat portions through the fluff portioning apparatus. Further, the rear conveyer belt 3 and the front conveyer belt 5 may transport meat portions at different speeds based on the second pulley 8 and the first pulley 7, respectively. The rear conveyer belt 3 and the front conveyer belt 5 may use separate belts or a same belt. The rear conveyer belt 3 and the front conveyer belt 5 may provide a flexible, large contact surface with rollers to minimize slippage or pile-up of the meat portions. In contrast, round belts of the related art have a tendency to creep in a lengthwise direction under tension, and slip on rollers. As illustrated in FIG. 1 of the instant specification, the front conveyer 4 and the rear conveyer 2 may each have a cover. The cover covers the front conveyer belt 5 and the rear conveyer belt 3.

In this embodiment, the rear conveyer 2 can be coupled to a grinder (not shown). In FIG. 1 of the instant specification, an adapter ring 10 is shown to illustrate how the rear conveyer is coupled to the grinder. The adapter ring 10 in this embodiment is specially designed for the fluff pack portioning apparatus. Adapter rings of the related art are too long for meat portions to reach the rear conveyer 2.

In FIG. 1 of the instant specification, a motor 6 may drive the first pulley 7 and the second pulley 8. As shown in FIG. 1, since the first pulley 7 and the second pulley have different sizes, the motor 6 may drive the front conveyer belt 5 and the rear conveyer belt 3 at different speeds. In an example, the front conveyer belt 5 may be driven at a speed between two to three times faster than a speed of the rear conveyer belt 3. A preferred embodiment may drive the front conveyer belt 5 at a speed two times faster than the rear conveyer belt 3. In an embodiment, the front conveyer belt 5 may be driven in a range of 20 revolutions per minute to 600 revolutions per minute. However, embodiments are not limited. The first pulley 7 and the second pulley may be a same size. Speed control may be used to control a height and a length of the meat portion. As an example, if a conveyer speed is slowed down, the meat portion may have a taller height and a shorter length.

An operation of the fluff portioning apparatus will now be described. A meat portion may be received from the grinder at a rear conveyer belt 3. The motor 6 of the fluff portioning apparatus 1 drives the second pulley 8 at a second speed. Thus, the rear conveyer belt 3 transports the meat portion away from the grinder at the second speed and towards the cutting blade 9.

In FIG. 1 of the instant specification, the cutting blade 9 cuts the meat portion into a first fluffed up portion of meat. As the rear conveyer 2 does not compress the meat, the meat portion is a loose amalgamation when it enters the cutting blade.

Then, in FIG. 1 of the instant specification, the first fluffed up portion of meat enters the front conveyer belt 5. The motor 6 of the fluff portioning apparatus 1 drives the first pulley 7 at a first speed. Thus, the front conveyer belt 5 transports the first fluffed up portion of meat away from the cutting board at the first speed.

In the operation of the fluff portioning apparatus, the first fluffed up portion of meat is created. The fluffed up portion of meat allows generous amounts of air inside the meat. Since the fluff portioning apparatus does not compress the meat, the first fluffed up portion of meat has a wavy, noodle-like pattern. The wavy, noodle-like pattern is a fresher, naturally looking meat. Therefore, the first fluffed up portion of the meat is an enhanced appearance, in comparison to compressed meat of the related art. The fluffed up portions of meat cooks more uniformly than compressed meat, due to the larger amount of air channels. The fluffed up portions of meat also maintains the same weight as compressed meat, while using less meat. Thus, fluffed up portions of meat are desirable for grocery stores or butcher's showcases.

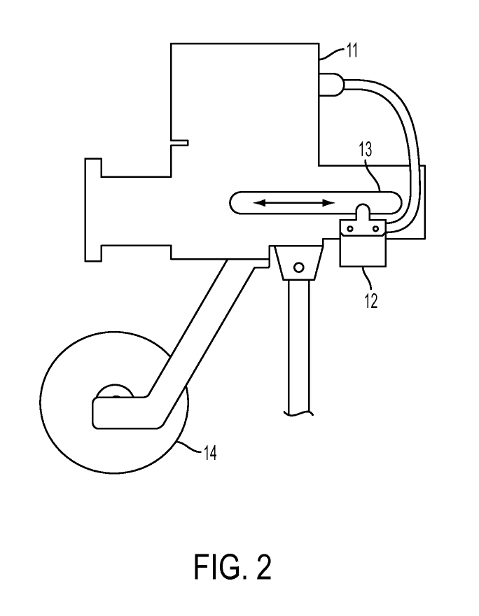

FIG. 2 is a diagram illustrating a side view of an exemplary embodiment of a fluff portioning apparatus with a photo-eye sensor. The photo-eye sensor 12 is an adjustable sensor. In FIG. 2 of the instant specification, the photo-eye sensor 12 is adjusted by sliding the photo-eye sensor 12 in a photo-eye slot 13. By adjusting the photo-eye sensor 12 through the photo-eye slot 13, the photo-eye sensor 12 controls the cutting blade 9 such that the meat portion is cut at a same uniform length. For example, the meat portion can be controlled by the photo-eye sensor 12 such that each fluffed up portion is cut at a two inch length. However, embodiments are not limited. The photo-eye sensor can be adjusted so that each fluffed up portion is cut at a range from a two inch length to a ten inch length. In further embodiments, the photo-eye sensor may have a background noise suppression capability, work at a low input voltage (i.e., 12 VDC), have an ultrasonic sensor, and have water-proof capabilities. In contrast, related art mechanical switches work at a standard input voltage (i.e., 120 VAC or 230 VAC), and have a tendency to fail due to ingress of water and contaminants.

In FIG. 2 of the instant specification, a power unit 11 can cover the cutting blade 9 in FIG. 1. The power unit 11 can include a controller (not shown) for driving the motor. In an embodiment, the controller may be a variable-frequency drive (VFD). Therefore, the controller may bring the motor to speed in less than 0.5 seconds, preventing meat accumulation. The power unit 11 may also be connected to the photo-eye sensor for controlling the cutting blade 9. In FIG. 2 of the instant specification, the fluff portioning apparatus may also include an automatic paper feeder 14. The automatic paper feeder 14 may dispense laminated paper for covering the front conveyer belt 5 and the rear conveyer belt 3. The laminated paper dispensed by the automatic paper feeder 14 helps the meat portion adhere together in a loose amalgamation as the meat portion is transported on the front conveyer belt 5 and the rear conveyer belt 3. The laminated paper of the automatic paper feeder 14 may also prevent slippage of the meat portion. The laminated paper may keep the meat portions separated on the conveyer belts, and helps the meat portions adhere to the conveyer belts.

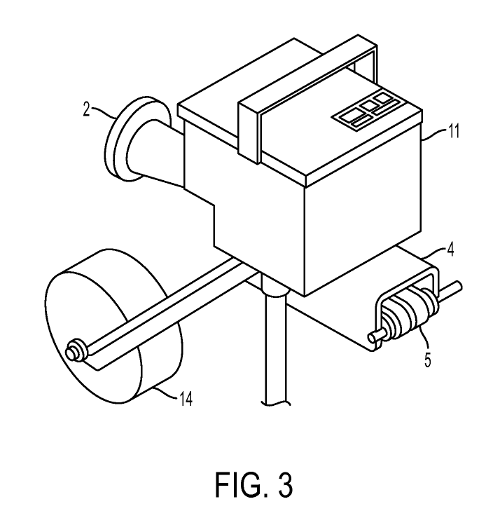

FIG. 3 is an overall configuration of the fluff portioning apparatus with the rear conveyer. FIG. 3 is similar to FIG. 1, except that the power unit 11 including the controller may cover the cutting blade 9. Further, FIG. 3 shows the automatic paper feeder 14. FIG. 3 also shows the rear conveyer 2, the front conveyer belt 5, and the front conveyer 4.

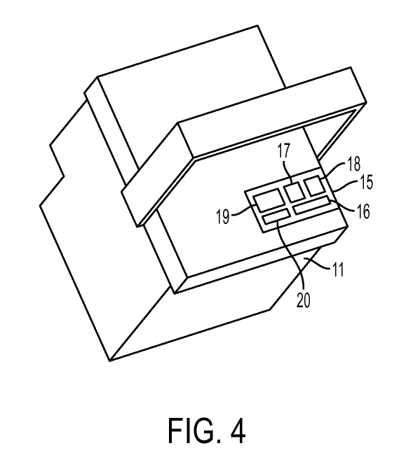

FIG. 4 is a diagram illustrating an exemplary embodiment of a fluff portioning apparatus with a timer counter. In FIG. 4 of the instant specification, a timer counter 15 may control the cutting blade 9 such that the meat portion is cut at a same uniform time. The same uniform time can be adjusted by several buttons in the timer counter 15, and can be displayed by a display 16. Examples of buttons included in the timer counter may include a reset button 17, a lock button 18, an up button 19, and a down button 20. The reset button 17 immediately resets the counter. The up button 19 and the down button 20 allow adjustments of the same uniform time in a timing step (i.e., ten milliseconds). The lock button 18 can set the same uniform time. The lock button 18 may also be used to prevent unauthorized change to the timer counter parameters.

In FIG. 4 of the example embodiment, the timer counter 15 can be adjusted in a range of 10 milliseconds to 9,999 seconds. This range allows for an unlimited length of the meat portions. In an example embodiment, the same uniform time may be set to 10 seconds.

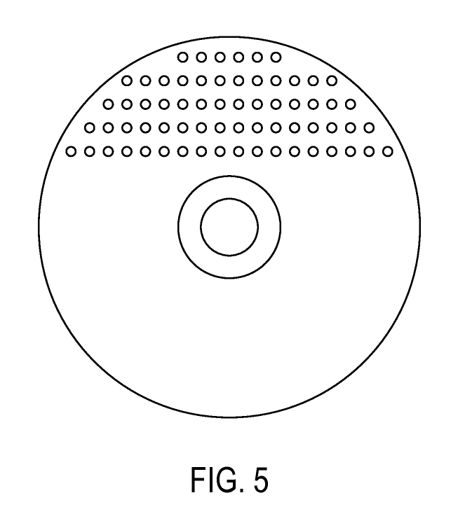

FIG. 5 is a diagram illustrating an exemplary embodiment of a grinding plate of a grinder. In FIG. 5 of the instant specification, the grinding plate has holes in a top half of the grinding plate. Each of the holes in the top half of the grinding plate has a 0.125 inch diameter. Further, the grinding plate in FIG. 5 of the instant specification has holes configured in a matrix configuration. The holes in the grinding plate restrict the meat portion to produce a loose amalgamation of meat. The holes are placed in the top half of the grinding plate so that the meat portion can exit the grinder and enter the rear conveyer 2. If holes are placed on a bottom half of the grinding plate, the meat portion going through the bottom half would not be able to enter the rear conveyer 2. However, embodiments are not limited. For example, the holes may be configured in a staggered configuration. In addition, the size of the holes and shapes may also be modified (for example, the holes may have a diameter of 0.138 inches). A regulator plate may also be used in conjunction with a grinding plate.

The meat portion described above is not limited to a type of animal. For example, the fluff portioning apparatus in the embodiments can grind turkey, chicken, pork, beef, fish, etc.

The foregoing is illustrative of example embodiments and is not to be construed as limiting thereof. Although a few example embodiments have been described, those skilled in the art will readily appreciate that many modifications are possible in the exemplary embodiments without materially departing from the novel teachings and advantages of the embodiments. Accordingly, all such modifications are intended to be included within the scope of the embodiments as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A fluff portioning apparatus, comprising:
a guide coupled to a meat grinder, the guide configured to receive a meat portion from the meat grinder and transport the meat portion away from the meat grinder in a direction towards a cutting blade;
the cutting blade configured to cut the meat portion received from the guide, creating a first meat portion; and
a front conveyer which transports the first meat portion in a direction away from the cutting blade using a front conveyer belt.

2. The fluff portioning apparatus of claim 1, further comprising:
a controller configured to drive the front conveyer at a first speed and the guide at a second speed, the first speed being faster than the second speed.

3. The fluff portioning apparatus of claim 1, wherein the guide is a rear conveyer which transports the meat portion away from the meat grinder and towards the cutting blade using a rear conveyer belt.

4. The fluff portioning apparatus of claim 2, wherein the controller drives the front conveyer belt at the first speed, the first speed being in a range of two to three times faster than the second speed of a rear conveyer belt.

5. The fluff portioning apparatus of claim 2, wherein the first speed is two times faster than the second speed.

6. The fluff portioning apparatus of claim 1, further comprising:
a controller configured to drive the front conveyer belt at a first speed.

7. The fluff portioning apparatus of claim 2, wherein the first speed of the front conveyer belt is driven in a range of 20 revolutions per minute to 600 revolutions per minute.

8. The fluff portioning apparatus of claim 1, further comprising:
a photo-eye sensor for detecting an edge of the meat portion, the photo-eye sensor controlling the cutting blade such that the meat portion is cut at a same uniform length.

9. The fluff portioning apparatus of claim 8, wherein the same uniform length is in a range of two inches to ten inches.

10. The fluff portioning apparatus of claim 9, wherein the same uniform length is two inches.

11. The fluff portioning apparatus of claim 1, further comprising:
a timer counter for controlling the cutting blade such that the meat portion is cut at a same uniform time.

12. The fluff portioning apparatus of claim 11, wherein the same uniform time is 10 seconds.

13. The fluff portioning apparatus of claim 1, wherein the fluff portioning apparatus turns off when the meat grinder is off.

14. The fluff portioning apparatus of claim 1, further comprising:
the meat grinder;
a grinding plate which attaches to the meat grinder; and
an adapter ring which interlocks and couples the meat grinder and the grinder plate to the fluff portioning apparatus.

15. A method of creating fluffed up portions of meat, comprising:
receiving the meat from a meat grinder; and
cutting the meat into fluffed up portions with a cutting blade of a fluff portioning apparatus.

16. The method of creating fluffed up portions of meat, according to claim 15,
wherein the fluff portioning apparatus further comprises a rear conveyor and a front conveyor,
wherein the meat is transported away from the meat grinder in a direction towards the cutting blade using the rear conveyer, and
wherein the fluffed up portions are transported in a direction away from the cutting blade using the front conveyer.

17. The method of creating fluffed up portions of meat, according to claim 15,
wherein a controller is configured to drive the front conveyer at a first speed and the rear conveyer at a second speed, the first speed being faster than the second speed.

18. The method of creating fluffed up portions of meat, according to claim 15, further comprising:
detecting an edge of the meat using a photo-eye sensor, the photo-eye sensor controlling the cutting blade such that the meat is cut at a same uniform length.

19. The method of creating fluffed up portions of meat, according to claim 15, further comprising:
controlling the cutting blade using a timer counter such that the meat is cut at a same uniform time.

20. The method of creating fluffed up portions of meat, according to claim 15, wherein the fluff portioning apparatus turns off when the meat grinder is off.

21. The method of creating fluffed up portions of meat, according to claim 15, wherein the fluff portioning apparatus further comprises:
the meat grinder;
a grinding plate which attaches to the meat grinder; and
an adapter ring which interlocks and couples the meat grinder and the grinder plate to the fluff portioning apparatus.

22. A method of creating fluffed up portions of meat in a fluff portioning apparatus, comprising:
receiving a meat portion from a grinder, the grinder attached to the fluff portioning apparatus with a grinding plate and an adapter ring;
transporting the meat portion away from the grinder at a second speed and towards a cutting blade;
cutting the meat portion into a first fluffed up portion of meat with the cutting blade; and
transporting the first fluffed up portion of meat away from the cutting blade at a first speed.
